(19) United States
(12) Patent Application Publication
(10) Pub. No.: US 2012/0149433 A1
(43) Pub. Date: Jun. 14, 2012

(54) SMART PHONE DISPLAY AND KEYBOARD EXTENSION

(75) Inventors: Fu-Ying Huang, San Jose, CA (US); Lidu Huang, Danville, CA (US); Jia-Yang Juang, Santa Clara, CA (US); Chiaoping Ku, Fremont, CA (US); Satoshi Yamamoto, San Jose, CA (US)

(73) Assignee: Hitachi Global Storage Technologies Netherlands B.V., Amsterdam (NL)

(21) Appl. No.: 12/966,920

(22) Filed: Dec. 13, 2010

(51) Int. Cl. H04W 88/02

(52) U.S. Cl. 455/557

(57) ABSTRACT

A device for providing an external display and keypad for a smart-phone. The device has a port for receiving the smart phone. The device does not have its own computing power, but uses the computing power of the smart phone itself, thereby allowing the device to be smaller, lighter and less expensive than a standard lap-top computer not notebook device. The device is configured with a port for receiving a smart-phone and preferably holds the smart phone so that does not extend above the surface of the device or is flush with the surface of the device. The device can also be configured to allow the smart phone itself to act as a numerical keypad adjacent to the keypad provided on the device.

### FIELD OF THE INVENTION

The present invention relates to smart phone accessories and more particularly to a device for connecting with a smart phone to provide improved screen and keyboard usage with the smart phone itself providing the computer processing capability.

### BACKGROUND OF THE INVENTION

In recent years mobile telephones have become much more than just telephones. Advanced mobile telephones, commonly referred to as “smart phones” have become powerful, ubiquitous computing devices, providing portable internet access, powerful computer processing ability and media storage. Such devices can access, store and play various media such as movies, photos, music, etc.

Advances in smart phone technology have reached a point that, for many users such smart phones provide their primary access to the internet. It may even come to pass in the foreseeable future that such smart phones may replace to some extend standard desktop or laptop computer systems. Their small size allow these devices to be always accessible, becoming an invaluable tool for a variety of applications including social networking, GPS based navigation, entertainment, communication in a variety of media, etc.

While the small size of such devices provides unprecedented convenience and accessibility for users, such devices suffer from certain limitations as a result of their very small size. For example, the display of such a device is limited by the size of the device. Therefore, no matter what resolution image can be achieved, the small screen size makes many viewing functions difficult, impractical or impossible. This can be an even greater problem for users who have difficulty viewing very small print or images, such as the visually impaired or elderly.

In addition, the physical input of data to such devices is limited by the size of the device itself. While many smart phones have keyboard capability, either by physical keys or a touch-screen, such pseudo-keyboards can be difficult to use especially for lengthy data input such as typing a document, entering data to a spreadsheet or other such data input. And, once again, the small size of such pseudo-keyboards can be even more problematic for users with visual impairment or problems with dexterity.

Therefore, while the evolution of smart phone technology presents a virtually unlimited growth in computer power, functional capability and wireless data speed, data input and display using such device continues to be limited.

### SUMMARY OF THE INVENTION

The present invention provides a device for providing an external display and keypad for a smart-phone. The device has a port for receiving the smart phone, and has a keypad and a display.

The device does not have its own computing power, but uses the computing power of the smart phone itself, thereby allowing the device to be smaller, lighter and less expensive than a standard lap-top computer or notebook device. The device is configured with a port for receiving a smart-phone and preferably holds the smart phone so that it does not extend above the surface of the device or is flush with the surface of the device.

The device can also be configured to allow the smart phone itself to act as a numerical keypad adjacent to the keypad provided on the device. This advantageously saves space by allowing the smart-phone, which is already being held within the device, to provide some of the keyboard function. This also, advantageously, provides a numerical keypad function that is not provided on standard laptop computers.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic perspective view of a display and keyboard device for use with a smart phone according to an embodiment of the invention;

FIG. 2 is a top down view of a portion of the device of FIG. 1, illustrating docking of a smart phone into the device;

FIG. 3 is a top down view of a portion of the device of FIGS. 2 and 3 showing how a smart phone can be used with the device to provide a number pad for inputting numerical data;

FIG. 4 is a side view taken from line 4-4 of FIG. 2 showing a flush mounting of a smart phone within the device and showing protruding bumps for holding the smart phone in place; and

FIG. 5 is a side view similar to that of FIG. 4 showing grooves for holding the smart phone in place during use.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

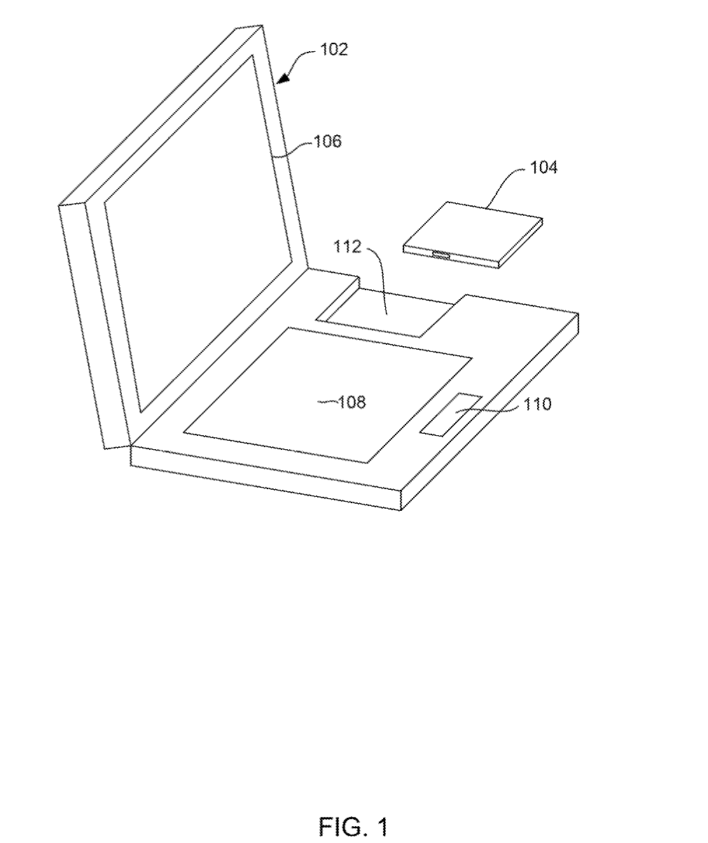

With reference to FIG. 1, a display/keyboard device 102 is shown for use with a smart phone device 104. The display/keyboard extension device 102 includes a display screen 106, and a keyboard 108. The display screen 106 can be a LCD or LED screen and the keyboard can include physical keys or a touch pad type screen. The device 102 may also include a touch pad 110 for moving a cursor or pointer on the screen 106. The display/keyboard device 102 also includes a port 112 for receiving the smart phone device 104.

The display/keyboard device 102 differs from a conventional laptop computer in that the device 102 does not, in and of itself, provide any significant computing ability. That is, the device 102 does not have a central processing unit (CPU). The computing power is provided solely or predominantly by the smart phone 104 itself. Therefore, the device 102 is only an extension of the smart phone for providing a more convenient data input and output interface.

This lack of any significant computing power (such as lack of a CPU) allows the device to be much lighter and much less costly than a conventional laptop. Therefore, a user who has already invested in a smart phone having all of the computing power needed by the consumer does not have to incur addition expense to purchase a separate laptop computer. The device 102 can also be constructed with a very small profile for additional convenience in transporting and handling the device 102. Therefore, since the device 102 can be much lighter and much thinner, a user can much more easily have such device accessible for use whenever needed such as at a coffee shop, when waiting at an airport, etc. The device can even be made small and light enough to be carried in a purse or other bag.

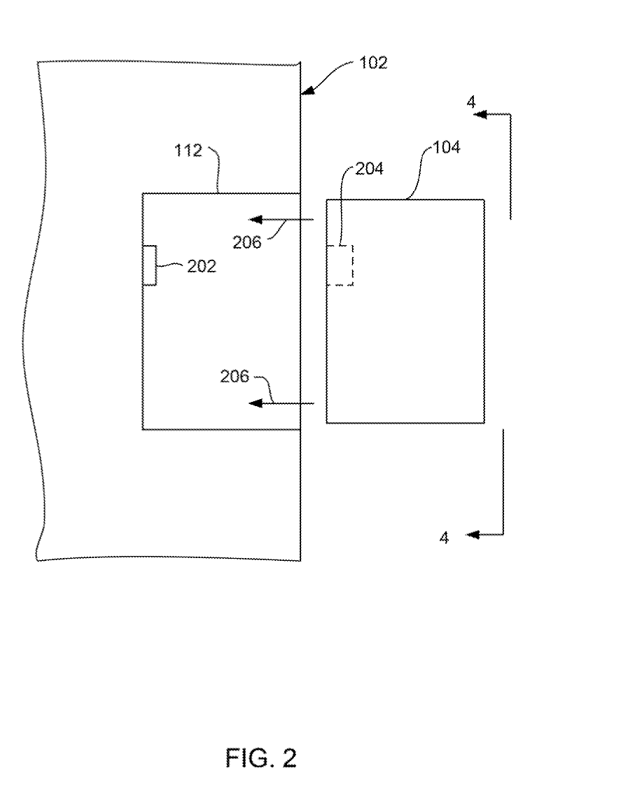

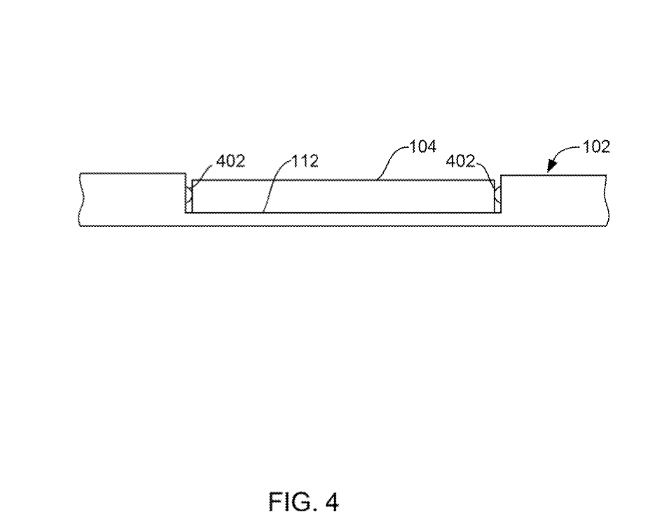

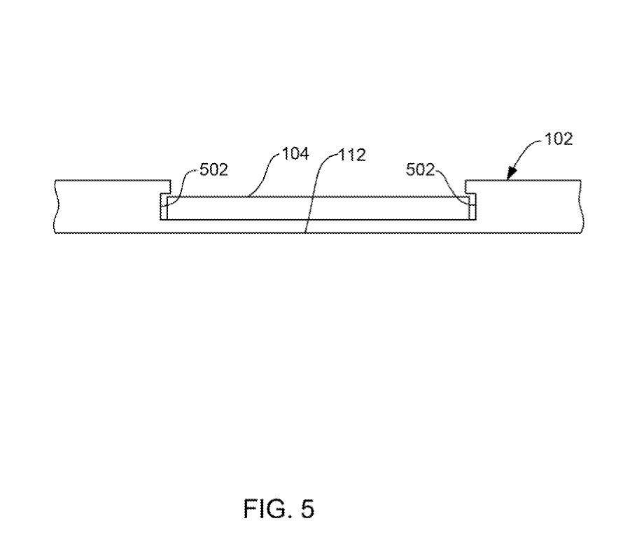

FIG. 2 is an enlarged view of a portion of the smart phone extension device 102, showing a top down view of the port 112. As can be seen in FIG. 2, the port 112 can be configured with a connector 202 that can be used to connect with a jack 204 of the smart phone 104. The connector 202 and jack 204 can be, for example Universal Serial Bus (USB) connectors or some other type of connector, either in use currently or yet to be developed. The port 112 can be configured so that the smart phone 104 can easily slide into the jack 112 as indicated by arrows 206. The port 112 can also be configured with detents, notches or groves for holding the smart phone 104 in place during use. Examples can be seen in FIGS. 4 and 5 which show side views of the port 112 as viewed from the right in FIG. 2. FIG. 2 shows a port 112 that is configured with bumps 402 that are configured to contact the smart phone 104 and hold it in place within the port 112. These bumps 402 can be constructed so that they are flexible to adapt to slight variations in the size of the smart phone 104 and to provide a slight frictional fit to the smart phone 104. FIG. 5 shows a port 112 that is configured with grooves or notches 502 that are configured to hold the smart phone in place. These grooves can be configured so that the smart phone 104 can be simply slid into the port 112 where it will be held securely in place. Further bumps or detents (not shown) can be provided to ensure that smart phone 104 does not inadvertently slip out of the port 112 such as by sliding out of the grooves 502 during use.

Also, as can be seen in FIGS. 4 and 5, the device 102 is configured such that the smart phone 104 fits entirely within the port 112 and does not extend above the surface 404 of the device 102. In other words, the smart phone is either flush with the surface 404 or sits below the surface 404 when installed into the device. This advantageously allows the device 102 to be closed by folding down the display 106 (FIG. 1) with the smart phone 104 still installed in the device. This allows the smart phone to be safely protected within the device 102 while the device 102 is closed with the smart phone 104 installed.

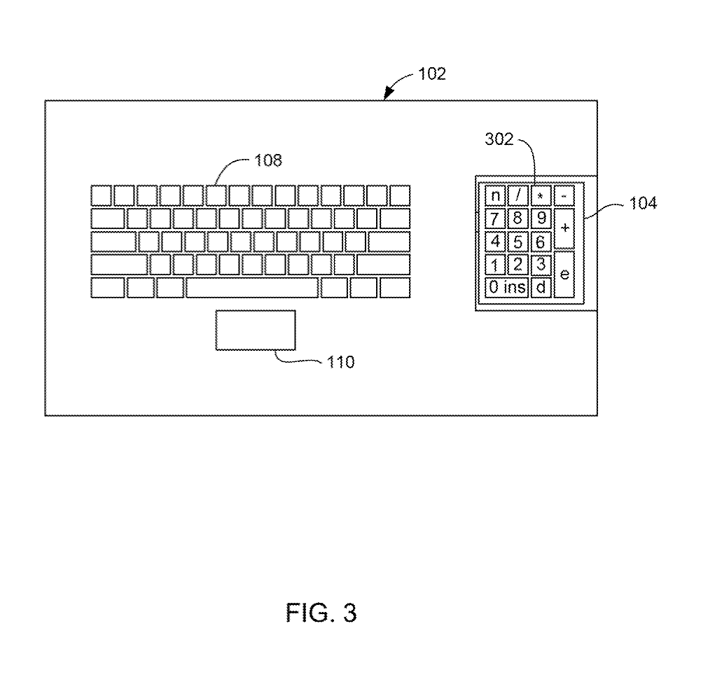

FIG. 3 shows a top down view of the key-board portion of the smart-phone extension device 102 with the display 106 (FIG. 1) removed for clarity. As any user of a standard lap-top computer will appreciate, the keyboard of a current lap-top computer does not include a number pad such as is commonly found on the larger external keyboards of a computer such as a desktop computer. These number pads can be very useful to a user who needs to input large amounts of numerical data, and the absence of such number pads on smaller lap-top computers can present a significant inconvenience to such users.

The present invention, as shown in FIG. 3, solves this problem without any significant additional expense and with requiring any extra use of space on the device 102. As shown in FIG. 3, the smart phone 104 itself can be used as a numerical keypad. If the smart phone has a touch screen, the smart-phone can be loaded with a software application (AP) that can cause it to display a numerical keyboard 302. Since this space is already being used to hold the smart phone 104, the use of this smart phone to also display and function as a numerical keypad does not present any additional space requirement, and also comes at virtually no additional cost. The software application (AP) can be preloaded onto the smart-phone extension device 102 (such as on a small amount of flash memory) so that it can automatically load to the smart phone 104 upon the docking of the smart phone 104 into the port 112 and connection of the connectors 202, 204 (FIG. 2). Therefore, the device 102 can have its own internal memory, such as a flash memory of hard disk drive.

The device can also have the capability to automatically sync with a smart phone to which it is connected. Such sync capability can be provided by software loaded on the memory of the device 102. This software can include computer readable instructions for recognizing the smart phone device that has been connected with the device 102 and for causing the smart phone 104 to display the number pad 302 (FIG. 3) previously described above. This automatic sync programming can also automatically import desired information from the smart phone 104 and display that information on the display screen 106. Such information can include, for example, a calendar, email or a desired web page. The device can be configured by a user to retrieve and display the desired type of data upon syncing with the smart phone 104.

In addition, the device 102 can have its own internal graphics enhancement unit. This graphics enhancement unit can receive digital input from the smart phone 104 that is coded for use in the small display of the smart phone, and enhance this input for use by the display screen 106 so that the image displayed on the display screen 106 can effectively have the same quality as if it had been generated by a standard lap-top computer, desktop computer or notepad device.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. An apparatus for displaying data from and inputting data to a smart-phone, comprising:
a port for receiving a smart-phone; and
a display for displaying data received from the smart-phone;
a keypad for providing data to the smart-phone;
wherein the display can be folded over the keypad to close the device while the smart phone is held within the port.

2. An apparatus as in claim 1 wherein the external display receives data directly from the smart phone without being processed by an intermediate processing unit.

3. An apparatus as in claim 1 wherein data is input from the keypad directly to the smart-phone without being processed by an intermediate processing unit.

4. An apparatus as in claim 1 wherein the apparatus has no internal central processing unit.

5. An apparatus as in claim 1 wherein the apparatus has no internal central processing unit and wherein computing power is provided by the smart-phone itself.

6. The apparatus as in claim 1 wherein the keypad is formed in a housing having an upper surface and the port is configured to receive the smart-phone such that the smart phone does not extend above the upper surface.

7. The apparatus as in claim 1 wherein the keypad is formed in a housing having an upper surface and the port is configured to receive the smart-phone such that the smart phone is flush with the upper surface.

8. The apparatus as in claim 1 wherein the port includes an electrical connector for connecting with a data port of the smart-phone.

9. The apparatus as in claim 1 wherein the keypad is formed in a housing, and wherein the port is a recess formed in the housing for receiving the smart-phone, the housing also including a connector for connecting with a data port of the smart-phone.

10. The apparatus as in claim 1 wherein the port is configured a device for holding the smart-phone securely in place within the housing.

11. The apparatus as in claim 1 wherein the port is configured with a groove for holding the smart-phone securely in place within the housing.

12. The apparatus as in claim 1 wherein the port is configured with raised buttons for holding the smart-phone securely in place within the housing.

13. The apparatus as in claim 1 wherein the keypad is formed on a housing having an upper surface, and wherein the display is hingedly connected with the housing so that that display can be folded over to cover the surface of the housing, and wherein the port is configured to receive the smart-phone such that the smart-phone does not extend above the surface of the housing, allowing the display to be folded over to cover the surface of the housing while the smart-phone is installed within the port, thereby by allowing the smart phone to be securely held within the apparatus while the display is folded over the surface of the housing.

14. The apparatus as in claim 1 further comprising data memory storage contained within the apparatus.

15. The apparatus as in claim 14 further comprising computer readable instructions stored in the data memory storage for syncing the apparatus with the smart-phone.

16. The apparatus as in claim 1 further comprising a graphics enhancement unit contained within the device for receiving graphics data from the smart-phone and enhancing the data for use by the display.

17. An apparatus for displaying data from and inputting data to a smart-phone, comprising:
a display for displaying data received from the smart-phone;
a keypad for providing data to the smart-phone, the keypad being held within a housing having a port for receiving a smart-phone, the port being located adjacent to the keypad; wherein
the smart-phone provides an auxiliary numerical keypad when installed into the port.

18. The apparatus as in claim 17 further comprising software loaded on memory within the housing, the software being deliverable to the smart-phone when the smart-phone installed in the port, the software providing computer readable instruction to allow the smart phone to function as a numerical keypad.

19. The apparatus as in claim 18 further comprising a connector configured for connecting with a data port of the smart-phone.

20. The apparatus as in claim 17 wherein the smart-phone provides computing power for operating the display and keypad.

21. The apparatus as in claim 17 wherein the apparatus includes no central processing unit and computing power for operating the display and keypad is provided by the smart-phone.

22. The apparatus as in claim 17 wherein the housing has an upper surface and wherein the smart-phone is configured to hold the smart-phone so that the smart-phone does not extend above the upper surface of the housing.

23. The apparatus as in claim 17 wherein the housing has an upper surface and wherein the smart-phone is configured to hold the smart-phone so that the smart-phone is flush with the upper surface of the housing.

24. The apparatus as in claim 17 further comprising:
data memory storage contained within the apparatus; and
computer readable instructions stored in the data memory storage for syncing the apparatus with the smart-phone.

25. The apparatus as in claim 17 further comprising a graphics enhancement unit contained within the device for receiving graphics data from the smart-phone and enhancing the data for use by the display.
